(19) United States
(12) Patent Application Publication
(10) Pub. No.: US 2026/0116473 A1
(43) Pub. Date: Apr. 30, 2026

(54) VEHICLE FRONT STRUCTURE

(71) Applicant: TOYODA GOSEI CO., LTD., Kiyosu-shi, Aichi-ken (JP)

(72) Inventors: Hiroshi TAKAKURA, Kiyosu-shi, Aichi-ken (JP); Koichi SUZUKI, Kiyosu-shi, Aichi-ken (JP); Masashi OTOYO, Kiyosu-shi, Aichi-ken (JP); Joji AOYAMA, Kiyosu-shi, Aichi-ken (JP); Takaki ITATSU, Kiyosu-shi, Aichi-ken (JP)

(21) Appl. No.: 19/357,816

(22) Filed: Oct. 14, 2025

(30) Foreign Application Priority Data
Oct. 30, 2024 (JP) 2024-190958

(51) Int. Cl. B62D 25/12

(52) U.S. Cl. CPC B62D 25/12

(57) ABSTRACT

A vehicle front structure includes a main body portion forming part of a vehicle body in a front portion of a vehicle, and an active hood device attached to the main body portion. The main body portion includes a plastic portion that primarily forms the main body portion, and a metal reinforcing plate embedded in the plastic portion. The active hood device includes an actuator configured to raise a front portion of a hood of the vehicle when activated, and a bracket for fixing the actuator to the main body portion. A fastening hole is formed in a region of the main body portion at which the reinforcing plate is embedded in the plastic portion. The bracket is fastened to the fastening hole via a fastening member.

### CROSS-REFERENCE TO RELATED APPLICATIONS

This application is based upon and claims the benefit of priority from Japanese Patent Application No. 2024-190958, filed on Oct. 30, 2024, the entire contents of which are incorporated herein by reference.

### BACKGROUND

### 1. Field

The present disclosure relates to a vehicle front structure.

### 2. Description of Related Art

JP2015-151056A disclose a radiator support to which an active hood device is fixed. The active hood device lifts a front end of the hood of a vehicle at the time of collision with an impact body such as a pedestrian.

The radiator support includes two radiator support side members, a radiator support upper member, and a radiator support lower member. The radiator support side members form the opposite ends in the vehicle width direction. The radiator support upper member extends in the vehicle width direction between the upper ends of the two radiator support side members to form an upper end portion of the radiator support. The radiator support lower member extends in the vehicle width direction between the lower ends of the two radiator support side members to form a lower end portion of the radiator support.

The active hood device includes two actuators that are activated upon a collision with an impact body, and two brackets. The actuators are fixed in the vicinity of the respective radiator support side members via the brackets.

In a related art, such a radiator support is formed from a metallic material so as to provide sufficient rigidity and strength to withstand the loads applied to the radiator support during activation of the actuators.

In such a radiator support, it is desirable to achieve weight reduction while maintaining the rigidity and strength necessary to withstand the above-mentioned loads. This issue is not limited to radiator supports for supporting a radiator, but can similarly arise in any vehicle front structure that includes a main body portion forming part of the vehicle body at the front of the vehicle, and an active hood device fixed to the main body portion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle front structure includes a main body portion forming part of a vehicle body in a front portion of a vehicle, and an active hood device attached to the main body portion. The main body portion includes a plastic portion made of a plastic and primarily forming the main body portion, and a metal reinforcing plate embedded in the plastic portion to reinforce the plastic portion. The active hood device includes an actuator configured to raise a front portion of a hood of the vehicle when activated, and a bracket for fixing the actuator to the main body portion. A fastening hole is formed in a region of the main body portion at which the reinforcing plate is embedded in the plastic portion, the bracket being fastened to the fastening hole via a fastening member.

Other features and aspects will be apparent from the following detailed description, the drawings, and the claims.

### BRIEF DESCRIPTION OF THE DRAWINGS

FIG. 1 is a partial cross-sectional view of a front portion of a vehicle in which a vehicle front structure according to a first embodiment is installed.

FIG. 2 is a rear view partially showing the vehicle front structure shown in FIG. 1.

FIG. 3 is a cross-sectional view taken along line 3-3 of FIG. 2.

FIG. 4 is a cross-sectional view taken along line 4-4 of FIG. 2.

FIG. 5 is a cross-sectional view of a vehicle front structure according to a second embodiment, in which a fastening hole is centrally located.

FIG. 6 is a cross-sectional view illustrating a process of mounting a bracket on a main body portion.

FIG. 7 is a cross-sectional view illustrating the process of mounting the bracket on the main body portion.

FIG. 8 is a cross-sectional view illustrating the process of mounting the bracket on the main body portion.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

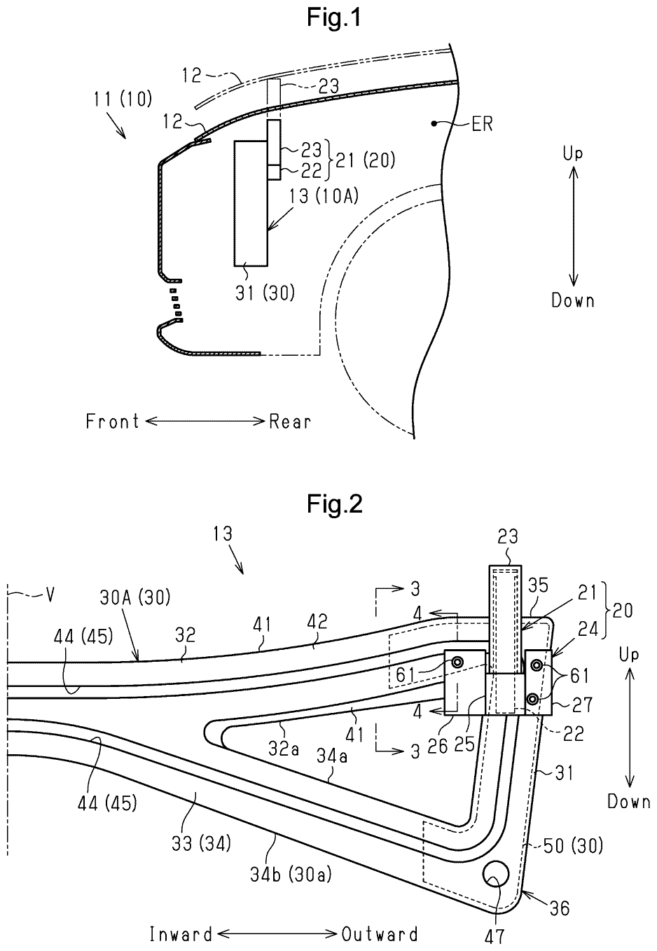

Vehicle front structures according to respective embodiments will now be described with reference to FIGS. 1 to 8. Hereinafter, the front-rear direction of a vehicle 10 will be referred to as a front-rear direction. The front side and the rear side in the front-rear direction are simply referred to as a front side and a rear side. In the present embodiment, the “rear side” corresponds to “one side in the front-rear direction.” The width direction of the vehicle 10 will simply be referred to as a vehicle width direction. The up-down direction of the vehicle 10 when the vehicle 10 is on a horizontal plane will be referred to as an up-down direction, and the upper side and the lower side in the up-down direction will simply be referred to as an upward side and a lower side, respectively.

### First Embodiment

First, a vehicle front structure 13 according to a first embodiment will be described with reference to FIGS. 1 to 4.

As shown in FIG. 1, a hood 12 and the vehicle front structure 13 are provided in a front portion 11 of the vehicle 10. The hood 12 covers the engine compartment ER from above. Opposite ends in the vehicle width direction of the rear end of the hood 12 are coupled to a vehicle body 10A with a pair of hood hinges (not shown). The hood 12 is supported with the hood hinges so as to be rotatable about an axis extending in the vehicle width direction. The hood 12 is configured to be lockable by a hood lock device (not shown) at a position at which the hood 12 closes the engine compartment ER shown in FIG. 1 (hereinafter, referred to as a closed position).

The vehicle front structure 13 is disposed below a front end of the hood 12. The vehicle front structure 13 includes active hood devices 20 and a main body portion 30 to which the active hood devices 20 are attached. Each component will now be described.

### Active Hood Device

As shown in FIGS. 1 and 2, each active hood device 20 includes an actuator 21 for lifting the hood 12 and a bracket 24 for fixing the actuator 21 to the main body portion 30. For illustrative purposes, FIG. 1 illustrates only the actuator 21 of the active hood device 20 in a simplified manner, and illustration of the bracket 24 is omitted.

The actuators 21 each have a columnar shape extending in the up-down direction as a whole, and include a piston 22 and a cylinder 23. The piston 22 incorporates a gas generator (not shown), which is electrically connected to an ECU (not shown) via a wire harness (not shown). A sensor (not shown) that detects or predicts a collision of a pedestrian with the vehicle 10 is electrically connected to the ECU. The ECU determines whether to activate the gas generator of the actuators 21 based on the signal input from the sensor. Each cylinder 23 has a cylindrical shape. The piston 22 is inserted into the cylinder 23. The cylinders 23 are configured to move upward relative to the piston 22 by the pressure of gas supplied into the pistons 22 when the gas generators are activated by the ECU. The actuators 21 are configured such that the cylinders 23 raise the front end of the hood 12 from the closed position to a raised position, indicated by a long-dash double-short-dash line in FIG. 1, by being raised by the gas pressure, while being in contact with the hood 12.

A side closer to a central portion of the vehicle 10 in the vehicle width direction is defined as an inner side, and a side away from the central portion of the vehicle 10 in the vehicle width direction is defined as an outer side.

As shown in FIG. 2, each bracket 24 is formed by processing a metal sheet, and includes a base portion 25, a first fixing portion 26, and a second fixing portion 27. The base portion 25 covers the lower end of the piston 22 from the rear side. The piston 22 is joined to an inner surface of the base portion 25 by any suitable method such as welding. The first fixing portion 26 extends inward from the base portion 25. The second fixing portion 27 extends outward from the base portion 25.

As shown in FIGS. 2 and 4, the first fixing portion 26 and the second fixing portion 27 each have one or more fastening holes 28, into which bolts 61 as fastening members are inserted. In the present embodiment, the first fixing portion 26 has one fastening hole 28, and the second fixing portion 27 has two fastening holes 28.

### Main Body Portion

As shown in FIGS. 1 and 2, the main body portion 30 forms part of the vehicle body 10A in the front portion 11 of the vehicle 10 (see FIG. 1). In the present embodiment, the main body portion 30 has a shape that is symmetrical with respect to an imaginary plane V (see FIG. 2) that passes through a central portion of the main body portion 30 in the vehicle width direction and is orthogonal to the vehicle width direction. Accordingly, hereinafter, the right-side portion of the main body portion 30 in the vehicle width direction will be described, and the description of the left-side portion may be omitted.

As shown in FIG. 2, the main body portion 30 includes a plastic portion 30A primarily forming the main body portion 30, and reinforcing plates 50 for reinforcing the plastic portion 30A. The main body portion 30 is integrally molded by injection-molding the plastic portion 30A using the reinforcing plates 50 as insert members, for example. The plastic portion 30A may be made of any suitable thermoplastic resin. In the present embodiment, the plastic portion 30A is made of a glass fiber-reinforced plastic in which glass fibers are mixed with a polypropylene resin. The plastic portion 30A includes two side portions 31, an upper portion 32, and two brace portions 33. The two side portions 31 are spaced apart from each other in the vehicle width direction and extend in the up-down direction. The upper portion 32 extends in the vehicle width direction and connects upper ends of the two side portions 31 to each other. The two brace portions 33 extend obliquely inward from the lower ends of the two side portions 31 and are connected to the upper portion 32. A hood latch (not shown) is attached, for example, to a central portion in the vehicle width direction of the upper portion 32. Each of the brace portions 33 is inclined upward as it extends inward. The two brace portions 33 collectively form an arch portion 34 that extends in a curved shape such that a central portion in the vehicle width direction bulges upward. An upper edge 34a of the arch portion 34 is connected to a lower edge 32a of the upper portion 32 at a central portion of the upper portion 32 in the vehicle width direction. The lower edge 34b of the arch portion 34 forms part of an outer peripheral edge 30a of the plastic portion 30A.

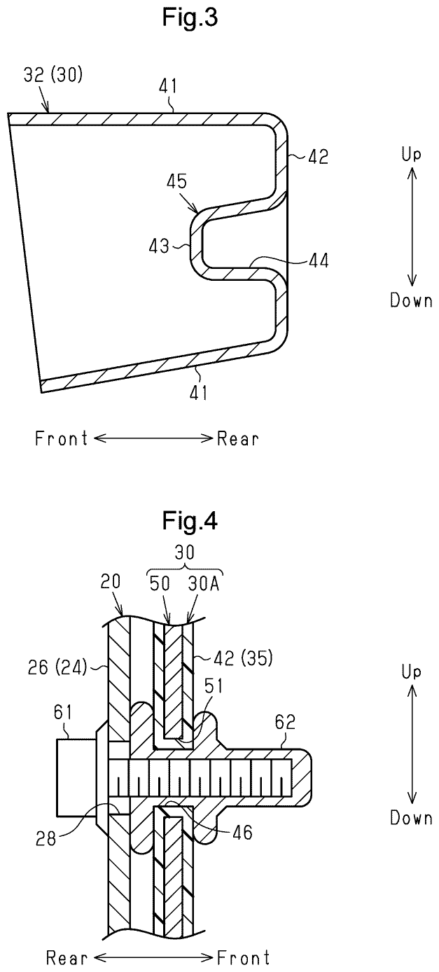

As shown in FIG. 3, the plastic portion 30A includes two side walls 41 and a bottom wall 42. The two side walls 41 extend in the front-rear direction and are spaced apart from each other. The bottom wall 42 connects rear ends of the side walls 41 to each other. The bottom wall 42 includes a ridge 43 protruding forward. The bottom wall 42 also includes a groove 44 opening rearward on the opposite side of the bottom wall 42 from the ridge 43 in the front-rear direction. The ridge 43 and the groove 44 form a bead 45.

As shown in FIG. 2, the bead 45 extends through each section of the plastic portion 30A. The bead 45 extends over the entirety of each section of the main body portion 30 in the direction in which that section extends. In the present embodiment, the bead 45 continuously extends over the entire main body portion 30.

As shown in FIGS. 2 and 4, one actuator 21 is fixed via a bracket 24 to each of regions at which one of the side portions 31 and the upper portion 32 of the main body portion 30 are connected to each other (hereinafter, referred to as connection portions 35). In each connection portion 35, the bottom wall 42 includes multiple fastening holes 46, through which bolts 61 are inserted. In the present embodiment, each connection portion 35 includes three fastening holes 46 corresponding to the number of the fastening holes 28.

As shown in FIG. 4, a blind nut 62 serving as a fastening member is attached to each fastening hole 46. With the bracket 24 overlaid on the rear side of the connection portion 35, a bolt 61 is inserted through each fastening hole 28, and a distal end of the bolt 61 is threaded into the blind nut 62. In this manner, the actuator 21 is fastened to the main body portion 30 from the rear side via the bracket 24.

As shown in FIG. 2, a fastening hole 47 is formed in each of the regions of the main body portion 30 at which the side portion 31 and the arch portion 34 are connected to each other (hereinafter, referred to as connection portions 36). Two front side members (not shown), which form part of the vehicle body 10A, are fastened to the two fastening holes 47 via fastening members (not shown) such as bolts.

As shown in FIGS. 2 and 4, the metal reinforcing plates 50 are embedded in the plastic portion 30A. In the present embodiment, each reinforcing plate 50 extends from the connection portion 35 to the connection portion 36 along the side portion 31. Specifically, the reinforcing plate 50 is embedded in the connection portions 35 and 36, and is embedded over the entire side portion 31 in the up-down direction. The reinforcing plate 50 includes hole portions 51 at positions overlapping the fastening holes 46 in the front-rear direction (see FIG. 4). The reinforcing plate 50 also includes hole portions (not shown) at positions overlapping the fastening holes 47 in the front-rear direction.

### Operation of the First Embodiment

The actuator 21 of each active hood device 20 is fixed to the main body portion 30 by fastening the bracket 24 to the fastening holes 46 of the main body portion 30 via the bolts 61 and the blind nuts 62 as fastening members.

According to the configuration of the vehicle front structure 13 of the present embodiment, the main body portion 30 is formed primarily of the plastic portion 30A. Accordingly, as compared with a comparative front structure having a main body portion formed of metal, the main body portion 30, and thus the vehicle front structure 13 as a whole, can be made lighter in weight.

If the main body portion 30 were simply formed of a plastic, the main body portion 30 would be more susceptible to deflection under the load applied to the main body portion 30 through the fastening holes 46 during activation of the actuator 21, as compared with a comparative vehicle front structure. As a result, lifting of the hood 12 by the actuators 21 could be insufficient. In this regard, according to the configuration of the vehicle front structure 13 of the present embodiment, the reinforcing plates 50 are embedded in the respective connection portions 35, at which the fastening holes 46 are formed in the main body portion 30, and in the side portions 31 and the connection portions 36, which are continuous with the connection portions 35. Accordingly, the connection portions 35, the side portions 31, and the connection portions 36 are reinforced by the reinforcing plates 50. This reduces the likelihood of deflection of the main body portion 30 even when the above-described load is applied to the main body portion 30.

### Advantages of the First Embodiment

(1-1) The vehicle front structure 13 of the vehicle 10 includes the main body portion 30 and the active hood devices 20. The main body portion 30 includes the plastic portion 30A and the metal reinforcing plates 50. The plastic portion 30A is made of plastic and primarily forms the main body portion 30. The reinforcing plates 50 are embedded in the plastic portion 30A to reinforce the plastic portion 30A. The main body portion 30 includes the connection portions 35, in each of which a reinforcing plate 50 is embedded in the plastic portion 30A. Each connection portion 35 includes fastening holes 46, to which the bracket 24 of the corresponding active hood device 20 is fastened via the bolts 61 and the blind nuts 62, serving as fastening members.

This configuration has the above-described characteristics. Accordingly, it is possible to reduce the weight of the main body portion 30 while maintaining the rigidity and strength capable of withstanding the load applied by the actuators 21 of the active hood devices 20.

(1-2) The plastic portion 30A includes the two side portions 31 and the upper portion 32. The fastening holes 46 are formed in each of the connection portions 35.

With this configuration, the bracket 24 is fastened, via the bolts 61 and blind nuts 62, to the fastening holes 46 formed in each of the two connection portions 35. As a result, one actuator 21 is fixed on each side of the main body portion 30 in the vehicle width direction. Accordingly, compared to a configuration in which a single actuator 21 is fixed only at a central portion of the upper portion 32 in the vehicle width direction, the hood 12 is lifted in a more stable manner.

Further, according to this configuration, each of the two connection portions 35 is reinforced by the reinforcing plate 50. Therefore, in the main body portion 30, it is possible to ensure sufficient rigidity and strength to withstand the loads applied from the actuators 21 of the two active hood device 20.

(1-3) The reinforcing plates 50 respectively extend from the two connection portions 35 to the connection portions 36 along the side portions 31.

In a case in which the fastening holes 46 are formed in the connection portions 35, the load applied from the actuator 21 through the fastening holes 46 acts also on the side portions 31, extending in the up-down direction from the connection portions 35. Therefore, if the reinforcing plates 50 were embedded only in the connection portions 35, the side portions 31, continuous with the connection portions 35, could deflect under the above-described load. In this regard, with the above-described configuration, in addition to the connection portions 35, the two side portions 31 are reinforced over their entirety in the up-down direction by the reinforcing plates 50. Moreover, the two connection portions 36 are also reinforced by the reinforcing plates 50. Consequently, even when the above-described load is applied to the main body portion 30, the side portions 31 and the connection portions 36, continuous with the side portions 31, are less likely to deflect. As a result, the main body portion 30 is further resistant to deflection. This increases the rigidity and strength of the main body portion 30.

### Second Embodiment

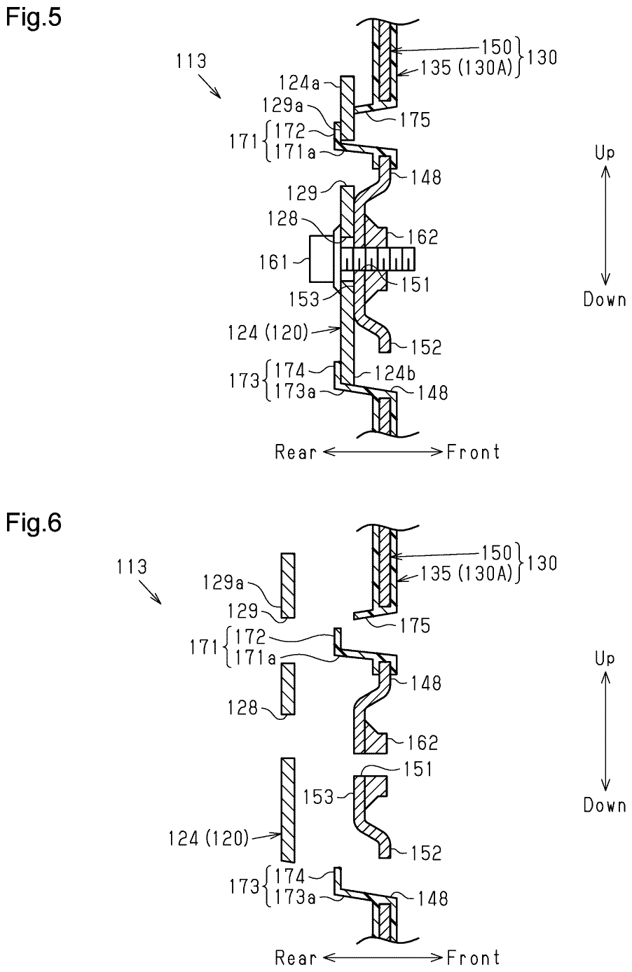

Next, a vehicle front structure 113 according to a second embodiment will be described with reference to FIGS. 5 to 8. The vehicle front structure 113 of the second embodiment is different from the vehicle front structure 13 of the first embodiment mainly in that, instead of including the fastening holes 46, it is provided with hole portions 151, which are exposed outward from a plastic portion 130A and serve as fastening holes

The description hereafter will focus on differences from the first embodiment. In the second embodiment, each component may be denoted by a reference numeral “1**” obtained by adding “100” to the reference numeral “**” of the same or corresponding component of the first embodiment. Thus, the overlapping description will be omitted.

### Main Body Portion

As shown in FIG. 5, a main body portion 130 includes a plastic portion 130A and reinforcing plates 150. A window 148 for exposing part of the embedded reinforcing plate 150 (hereinafter referred to as an exposed portion 152) is formed in each connection portion 135 of the plastic portion 130A. On the opening edge of the window 148, a first engagement projection 171 and a second engagement projection 173 are formed so as to be disposed on opposite sides of the exposed portion 152 in the up-down direction. The first engagement projection 171 and the second engagement projection 173 are integrally molded with the plastic portion 130A. In the present embodiment, the first engagement projection 171 corresponds to “a projection that is inserted into a hole portion formed in a bracket.”

The first engagement projection 171 is located above the exposed portion 152. The first engagement projection 171 includes a base portion 171a, which projects rearward from the opening edge of the window 148, and a hook portion 172, which is bent and extends upward from the rear end of the base portion 171a. The base portion 171a is inserted into a hole portion 129 formed in the bracket 124. The hook portion 172 is engaged with an opening edge 129a of the hole portion 129 by coming into contact with the opening edge 129a from the rear side.

The second engagement projection 173 is located below the exposed portion 152. The second engagement projection 173 includes a base portion 173a, which projects rearward from the opening edge of the window 148, and a hook portion 174, which is bent and extends upward from the rear end of the base portion 173a. The base portion 173a is in contact with a lower end 124b of the bracket 124 from below. The hook portion 174 is engaged with the lower end 124b by coming into contact with the lower end 124b from the rear side.

As shown in FIG. 5, the main body portion 130 includes a support projection 175 above the first engagement projection 171 with a gap therebetween. The support projection 175 is formed integrally with the plastic portion 130A. The support projection 175 projects rearward. The support projection 175 comes into contact with an upper end 124a of the bracket 124 from the front side to support the upper end 124a.

As shown in FIG. 5, the exposed portion 152 includes a hole portion 151 as a fastening hole, into which a bolt 161 is inserted. A fastening portion 153, which is a portion of the exposed portion 152 in which the hole portion 151 is formed, bulges rearward and contacts the bracket 124. A blind nut 162 is joined to a front surface of the fastening portion 153 by welding or the like.

### Mounting of the Bracket

Hereinafter, a process of mounting the bracket 124 will be described with reference to FIGS. 6 to 8.

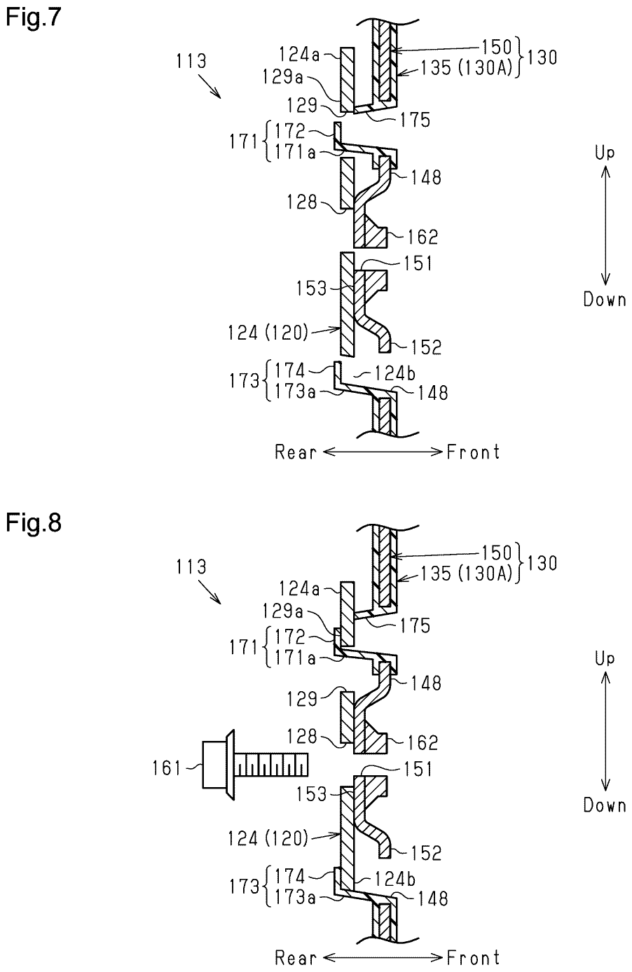

As shown in FIGS. 6 and 7, when the bracket 124 is fastened to the main body portion 130, first, the bracket 124 is brought close to the connection portion 135 from the rear side, so that the first engagement projection 171 is inserted into the hole portion 129.

The hole portion 129 is configured to restrict relative movement of the first engagement projection 171 in the vehicle width direction, and to allow relative movement of the first engagement projection 171 in the up-down direction. Accordingly, as shown in FIGS. 7 and 8, when the first engagement projection 171 is moved upward along the hole portion 129, the bracket 124 is slid downward with relative to the main body portion 130.

As shown in FIG. 8, when the first engagement projection 171 is moved to the upper end of the hole portion 129, the bracket 124 is guided to a position at which it can be fastened to the hole portion 151; that is, a position at which the fastening hole 128 communicates with the entire hole portion 151 in the front-rear direction. At this time, the base portion 173a of the second engagement projection 173 is in contact with the lower end 124b of the bracket 124. Accordingly, the bracket 124 is restricted from sliding further downward from the position shown in FIG. 8. Further, at this time, the support projection 175 and the fastening portion 153 are in contact with the bracket 124 from the front side. The hook portions 172 and 174 are respectively engaged with the opening edge 129a and the lower end 124b from the rear side. In other words, the bracket 124 is sandwiched in the front-rear direction by the hook portions 172 and 174, the support projection 175, and the fastening portion 153. As a result, the bracket 124 is retained at a position at which it can be fastened to the hole portion 151.

Then, as shown in FIG. 8, the bolt 161 is inserted into the fastening hole 128 and the hole portion 151, and the distal end of the bolt 161 is threaded into the blind nut 162. Consequently, the actuator (not shown) is fastened to the main body portion 130 from the rear side via the bracket 124. The actuator is fixed to each connection portion 135 via the bracket 124 by fastening one fastening hole 128 and one hole portion 151 to each other.

### Operation and Advantages of the Second Embodiment

In addition to the advantages (1-1) to (1-3) of the first embodiment, the present embodiment has the advantage described below.

(2-1) The bracket 124 is fastened to the hole portion 151 from the rear side. The plastic portion 130A includes the first engagement projection 171, which is inserted into the hole portion 129 formed in the bracket 124. The hole portion 129 is configured to guide the bracket 124 to a position at which the bracket 124 can be fastened to the hole portion 129 (fastening hole) when the first engagement projection 171 moves upward along the hole portion 151.

With this configuration, when the first engagement projection 171 moves upward along the hole portion 129 of the bracket 124, the bracket 124 is guided to a position at which it is fastened to the hole portion 151 (fastening hole). This allows the bracket 124 to be efficiently fastened to the hole portion 151 (fastening hole).

(2-2) The first engagement projection 171 includes the hook portion 172, which is engaged with the opening edge 129a of the hole portion 129 formed in the bracket 124.

With this configuration, when the hook portion 172 of the first engagement projection 171 is engaged with the opening edge 129a of the hole portion 129, the bracket 124 is retained at a position at which the bracket is fastened to the hole portion 151. This facilitates fastening of the bracket 124 to the hole portion 151.

(2-3) The plastic portion 130A further includes the second engagement projection 173. The second engagement projection 173 is engaged with the lower end 124b of the bracket 124.

With this configuration, the combined action of the first engagement projection 171 and the second engagement projection 173 enables the bracket 124 to be firmly retained by the main body portion 130 at a position at which the bracket 124 can be fastened to the hole portion 151. This further facilitates fastening of the bracket 124 to the hole portion 151.

(2-4) The actuator is fixed to each connection portion 135 via the bracket 124 by fastening one fastening hole 128 and one hole portion 151 to each other.

To increase the rigidity and strength of a main body portion so as to withstand loads applied from an actuator, the main body portion may be provided with multiple fastening holes, and the bracket 124 may be fastened to the fastening holes via multiple fastening members. However, in such a case, the number of components may increase in proportion to the number of fastening members provided.

In this regard, in the above-described configuration, the connection portion 135 is reinforced by the reinforcing plate 150, and the bracket 124 is firmly retained in the fastening position by the two engagement projections 171 and 173 integrally molded with the plastic portion 130A. Therefore, it is unnecessary to fasten the bracket 124 to the connection portion 135 at multiple fastening locations. In other words, apart from the hole portion 151 serving as a fastening hole, it is unnecessary to provide the main body portion 130 with any additional fastening holes. Accordingly, the number of fastening members is reduced. This reduces the number of components of the main body portion 130.

### Modifications

The above-described embodiment may be modified as follows. The above-described embodiment and the following modifications can be combined as long as the combined modifications remain technically consistent with each other.

In the first embodiment, the number of the fastening holes 46 formed in each connection portion 35 of the main body portion 30 is not limited to three, and may be four or more. In this case, the number of the fastening holes 28 formed in each of the fixing portions 26 and 27 of the bracket 24 may be changed in accordance with the number of the fastening holes 46.

The bead 45 is not limited to being continuous over the entire main body portion 30 as described in the first embodiment. For example, multiple beads 45 may be arranged at intervals over the entire main body portion 30.

The groove 44 may be omitted from the bottom wall 42. In other words, the surface of the bottom wall 42 on the side opposite to the ridge 43 in the front-rear direction may be a smooth surface.

The main body portion 30 does not necessarily need to have the bead 45. In other words, both the ridge 43 and the groove 44 may be omitted from the bottom wall 42. In this case, it is sufficient to provide ribs at appropriate locations of the main body portion 30 to reinforce the main body portion 30.

The vehicle front structure 13 is not limited to a structure in which the actuators 21 are fixed to the main body portion 30 from the rear side. The actuators 21 may be fixed to the main body portion 30 from the front side. Accordingly, the bottom wall 42 does not necessarily need to connect the rear ends of the two side walls 41 to each other, and may connect the front ends of the two side walls 41 to each other. In this modification, the “front side” corresponds to “one side in the front-rear direction.”

The reinforcing plate 50 does not necessarily need to extend from the connection portion 35 to the connection portion 36 along the side portion 31 as illustrated in the first embodiment. For example, reinforcing plates may be independently embedded in each of the connection portion 35, the side portion 31, and the connection portion 36. Further, the reinforcing plate 50 may be absent in the side portion 31 and the connection portion 36.

The vehicle front structure 13 is not limited to the structure in which the active hood devices 20 are mounted one by one at the opposite sides of the main body portion 30 in the vehicle width direction, as illustrated in the first embodiment. For example, only one active hood device 20 may be attached to the central portion of the upper portion 32 in the vehicle width direction. In this case, the reinforcing plate 50 is not limited to being embedded in the connection portion 35 as illustrated in the first embodiment, and it would be sufficient if a reinforcing plate 50 be embedded in the central portion.

The shape of the engagement projections 171 and 173 does not necessarily need to be a shape in which the hook portions 172 and 174 are bent and extend from the rear ends of the base portions 171a and 173a, as illustrated in the second embodiment. For example, the hook portions 172 and 174 may be omitted from at least one of the engagement projections 171 and 173.

The engagement projections 171 and 173 are not limited to those employed only in the vehicle front structure 113 illustrated in the second embodiment, and can also be employed in the vehicle front structure 13 of the first embodiment. In this case, the engagement projections 171 and 173 may be appropriately disposed at positions in the vicinity of the fastening holes 46 in the plastic portion 30A.

In the second embodiment, the second engagement projection 173 may be omitted from the plastic portion 130A.

In the second embodiment, the first engagement projection 171 may be omitted from the plastic portion 130A. In these cases, a fastening hole may be further provided in addition to the hole portion 151 so that the bracket 124 is fastened to the multiple fastening holes via multiple fastening members.

The vehicle front structure according to the present disclosure may also be embodied as a structure commonly referred to as a radiator support, which supports a radiator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle front structure, comprising:
a main body portion forming part of a vehicle body in a front portion of a vehicle; and
an active hood device attached to the main body portion, wherein
the main body portion includes:
a plastic portion made of a plastic and primarily forming the main body portion; and
a metal reinforcing plate embedded in the plastic portion to reinforce the plastic portion,
the active hood device includes:
an actuator configured to raise a front portion of a hood of the vehicle when activated; and
a bracket for fixing the actuator to the main body portion, and
a fastening hole is formed in a region of the main body portion at which the reinforcing plate is embedded in the plastic portion, the bracket being fastened to the fastening hole via a fastening member.

2. The vehicle front structure according to claim 1, wherein
a width direction and an up-down direction of the vehicle are defined as a vehicle width direction and an up-down direction,
the plastic portion includes:
two side portions spaced apart from each other in the vehicle width direction and extending in the up-down direction; and
an upper portion extending in the vehicle width direction and connecting upper ends in the up-down direction of the side portions to each other, and
the fastening hole is one of two fastening holes each formed in a region at which one of the side portions and the upper portion are connected to each other.

3. The vehicle front structure according to claim 2, wherein the reinforcing plate is one of two reinforcing plates, each reinforcing plate including a portion that is embedded in the corresponding side portion and extends over the entire side portion in the up-down direction.

4. The vehicle front structure according to claim 1, wherein
a front-rear direction of the vehicle is defined as a front-rear direction,
the bracket is fastened to the fastening hole from one side in the front-rear direction,
the plastic portion includes a projection that projects toward the one side in the front-rear direction and is inserted into a hole portion formed in the bracket, and
the hole portion is configured to guide the bracket to a position at which the bracket can be fastened to the fastening hole when the projection is moved along the hole portion.
